(19) United States
(12) Patent Application Publication
(10) Pub. No.: US 2010/0140573 A1
(43) Pub. Date: Jun. 10, 2010

(54) LIFTING DEVICE

(75) Inventors: Dirk Jan Siemers, Ratzeburg (DE); Bernhard Ruhnke, Geesthacht (DE)

Correspondence Address: HOVEY WILLIAMS LLP, 10801 Mastin Blvd., Suite 1000, Overland Park, KS, 66210, US

(73) Assignee: GKSS-Forschungszentrum Geesthacht GmbH, Geesthacht (DE)

(21) Appl. No.: 12/633,557

(22) Filed: Dec. 8, 2009

(30) Foreign Application Priority Data
Dec. 8, 2008 (DE) 102008062317.2

(51) Int. Cl. B66F 3/16; B66F 3/18

(52) U.S. Cl. 254/103

(57) ABSTRACT

Represented and described is a lifting device having a housing, a lifting spindle that is cylindrical and has an external thread on the outer surface, a threaded bush that surrounds the lifting spindle and has an internal thread that is in engagement with the external thread and a drive unit for the rotating drive of the threaded bush, wherein the lifting spindle is mounted in the housing so as to be displaceable in its axial direction and non-rotatable. The object to provide a lifting device that has as short an installation length as possible in the axial direction of the lifting spindle is achieved in that the lifting spindle is in the form of a hollow cylinder, in that a dome is located in the interior of the lifting spindle and is connected in a non-rotatable manner to the housing and in that the lifting spindle is mounted on the dome so as to be non-rotatable and axially displaceable.

### CROSS-REFERENCE TO RELATED APPLICATION

The present application claims the benefit of and priority from German Patent Application Serial No. DE 10 2008 062 317.2, filed Dec. 8, 2008, the entire disclosure of which is hereby incorporated by reference herein.

### BACKGROUND OF THE INVENTION

1. Field of the Invention

The present invention relates to a lifting device having a housing, a lifting spindle that is cylindrical and has an external thread on the outer surface, a threaded bush that surrounds the lifting spindle and has an internal thread that is in engagement with the external thread and a drive unit for the rotating drive of the threaded bush, wherein the lifting spindle is mounted in the housing so as to be displaceable in its axial direction and non-rotatable.

2. Discussion of the Prior Art

DE 29 20 133 B1 makes known a lifting device with two threaded spindles that are able to be moved in a telescopic manner towards one another, the outer threaded spindle also being set in rotation when the inner threaded rod is rotated. In this case the two threaded spindles are displaced in the longitudinal direction at the same time. Over and above this, DE 236 726 A makes known a lifting device with a hollow lifting spindle that is guided by a nut and is moved out of a housing when the nut is rotated.

The prior art, such as, for example, EP 1 473 268 A2, makes known lifting devices, where a solid lifting spindle is mounted so as to be non-rotatable in its axial direction but displaceable and is surrounded by a threaded bush that is driven in a rotating manner. When the threaded bush rotates, the lifting spindle is displaced in the axial direction such that an object mounted at the end of the lifting spindle can be raised or lowered. In this case, the installation length in the axial direction of the lifting spindle is determined, on the one hand, by the length of the threaded bush and, on the other hand, by the length of the guide elements that are located in the axial direction in front of and behind the threaded bush and hold the lifting spindle so as to be axially displaceable but non-rotatable.

If this type of lifting device is to be used to lift an object in a positionally precise manner within a room that has a predetermined ceiling height, the height of the object being the same size as the height of the room, the problem arises that a lifting device used for this purpose must have as small an installation size as possible in the axial length of the lifting spindle.

In the case of lifting devices known in the prior art, the installation size is determined, on the one hand, by the length of the threaded bush, which at the same time also establishes the maximum total travel of the lifting device, and, on the other hand, by the axial length of the guide elements located in front of and behind the threaded bush. This means that the total travel provided by the lifting device is reduced by the guide elements when the maximum installation size of the lifting device is predetermined in a fixed manner.

### SUMMARY

Proceeding from the state of the art, consequently, it is the object of the present invention to provide a lifting device that has as short an installation size as possible in the axial direction of the lifting spindle.

This object is achieved in that the lifting spindle is in the form of a hollow cylinder, that a dome is located in the interior of the lifting spindle and is connected in a non-rotatable manner to the housing and that the lifting spindle is mounted on the dome so as to be non-rotatable and axially displaceable.

The achievement of the dome being located in the interior of the lifting spindle is that with a large total travel, a more compact design is nevertheless possible compared to the prior art as it is no longer necessary to have additional guide elements located in the axial direction in front of and behind the lifting spindle, rather these are provided in the interior of the hollow-cylindrical lifting spindle.

In a preferred embodiment, the drive unit has, on the one hand, a worm gear mounted on the threaded bush and, on the other hand, a worm shaft that is in engagement with said worm gear and in turn is driven in a rotating manner. This type of design makes it possible for a comparatively high torque to be exerted onto the threaded bush such that the lifting device is capable of lifting very large loads.

In this case it is particularly preferred when an axially insertable shaft coupling is provided between the worm shaft and another bevel gear gearing, for example a bevel gear, in order to dampen rotational vibrations.

To guide the lifting spindle through the dome, guide rails are mounted in a preferred embodiment either on the dome or the lifting spindle, and in addition carriages are provided that run in the guide rails and are secured to that element that does not have the guide rails. In this way it is possible to realize the lifting spindle mounted on the dome so as to be axially displaceable, but non-rotatable.

In this case, in another preferred manner, a plurality of guide rails can be distributed over the circumference of the dome, it being possible for the dome to have between the guide rails outwardly pointing projections that serve to increase the torsional rigidity of the dome.

Other arrangements are also conceivable as an alternative to the arrangement with guide rails and carriages, the achievement of which is that the lifting spindle is coupled to the dome so as to be axially displaceable but non-rotatable. For example, the dome can be circular in cross section and be provided with one or more tracks that extend in the axial direction. A bush can then be mounted on the inner circumferential surface of the lifting spindle and the dome with the tracks extends through said bush, wherein balls held in the bush extend into the tracks such that the bush is not able to rotate relative to the dome but is able to be displaced in an axial manner.

As an alternative to said ball bush guide, it is also conceivable for the dome to be developed as a toothed shaft and the lifting spindle to be fixedly connected to a bush in the interior, said bush having a bore realized corresponding to the toothing such that, in this case too, the lifting spindle is coupled to the dome so as to be locked against rotation but displaceable.

Finally it is also conceivable for the connection between dome and lifting spindle to be effected by means of a so-called polygon connection, the dome therefore having a cross section that deviates from a spherically symmetrical form and the bush secured to the lifting spindle being provided with a corresponding bore.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

The present invention is explained below by way of a drawing representing an exemplary embodiment. The drawing shows in:

FIG. 1 a section in the axial direction of an exemplary embodiment of a lifting device according to the invention,

FIG. 2 a section along the line II-II in FIG. 1,

FIG. 3 a first perspective representation of the exemplary embodiment in FIG. 1, and

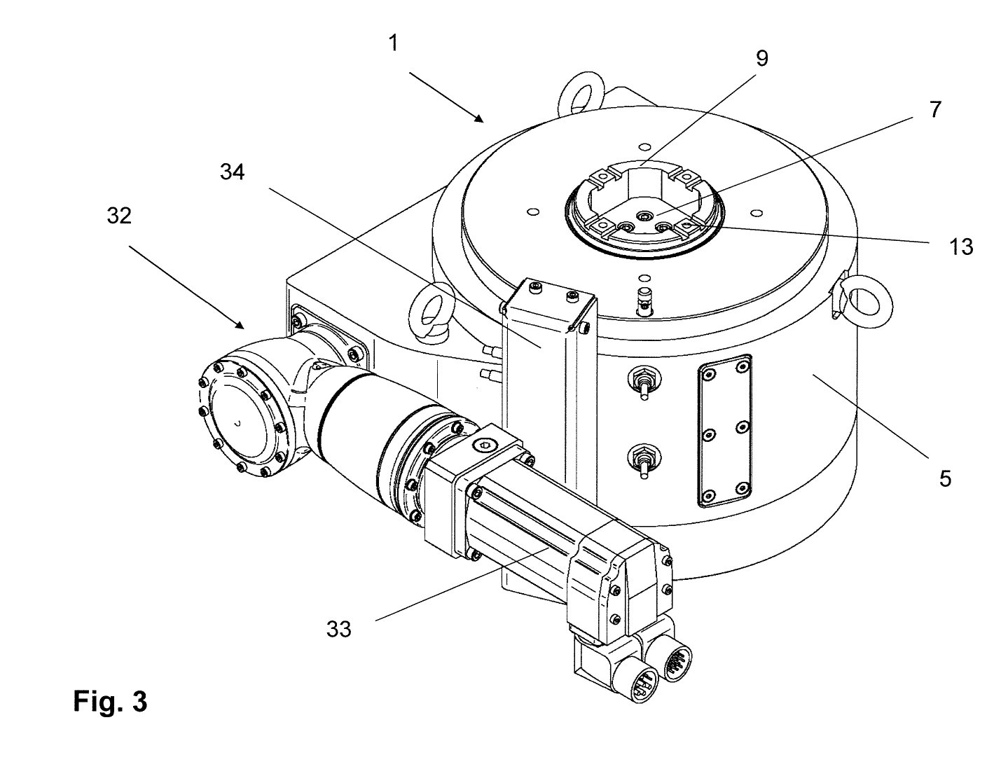

FIG. 4 a second perspective representation of the exemplary embodiment in FIG. 1.

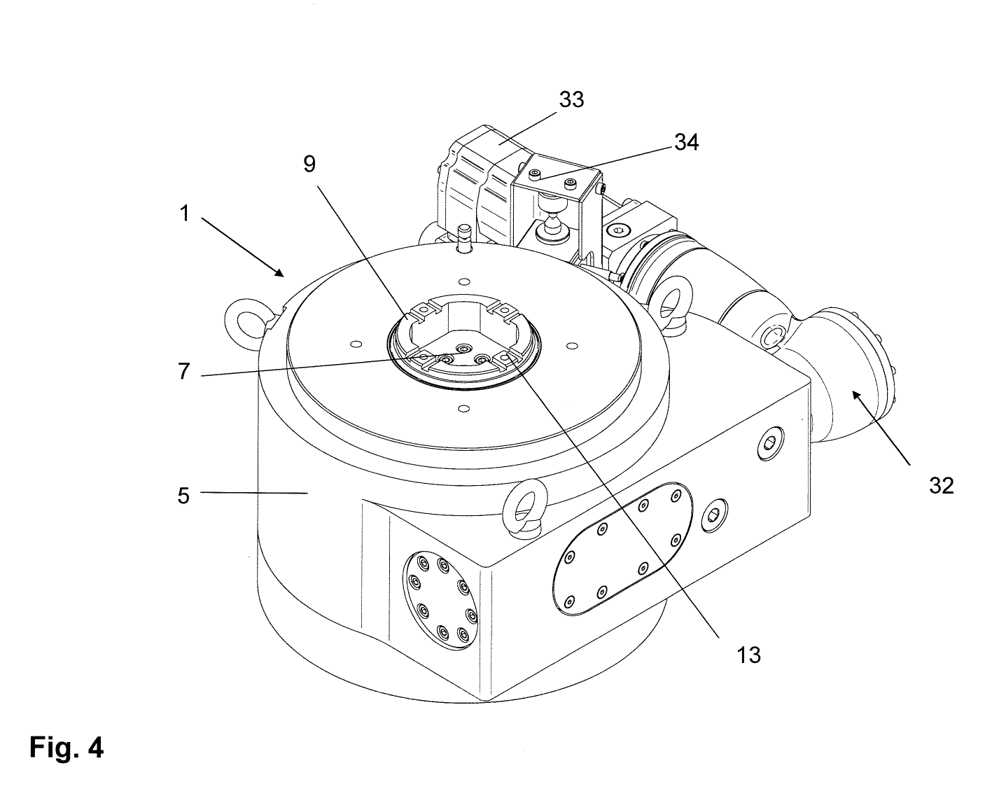

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

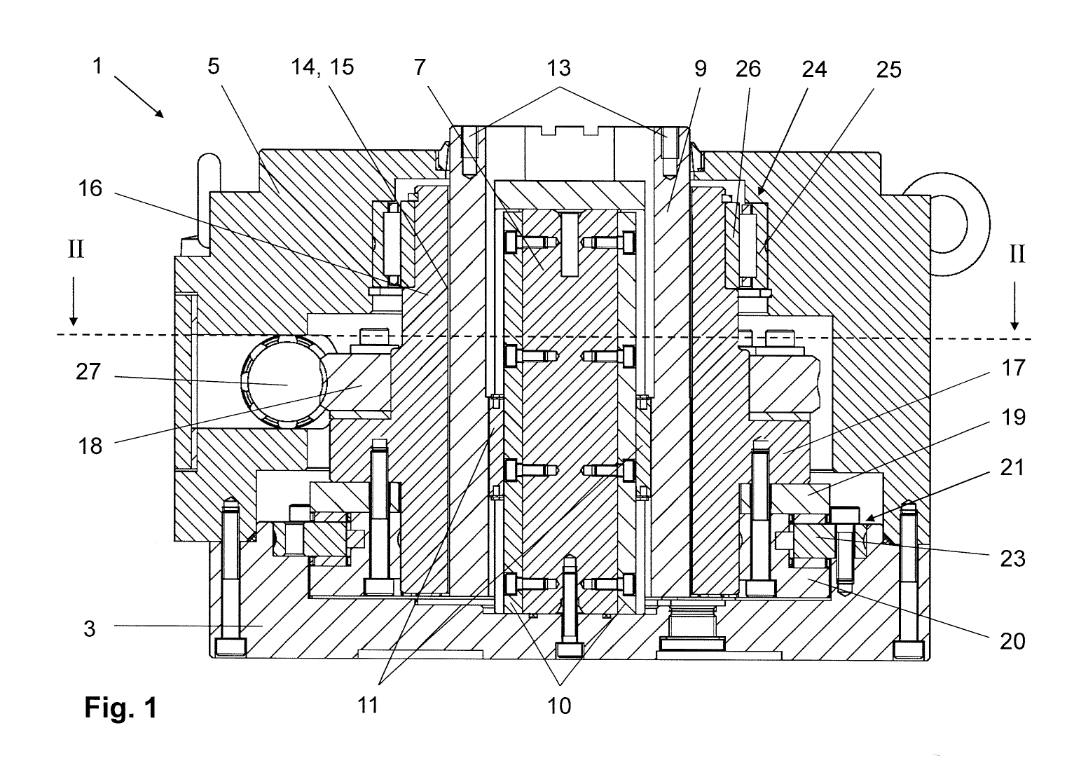

FIG. 1 represents an exemplary embodiment of a lifting device 1 according to the invention. The lifting device 1 has a base plate 3, which can rest on a surface area and to which a housing 5 and a dome 7, which extends vertically from the base plate 3, are screw-connected.

The dome 7 is surrounded by a lifting spindle 9 that is in the form of a hollow cylinder. A linear guide is provided on the dome 7, said linear guide including four guide rails 10 that are screw-connected to the dome 7, are distributed uniformly over the circumference of the dome 7 and extend in each case over the entire axial length of the dome 7. Moveable carriages 11 run in the guide rails 10 in the axial direction of the dome 7, said moveable carriages being fixedly connected to the inside surface of the cylindrical lifting spindle 9. This arrangement of guide rails 10 and carriages 11 couples the lifting spindle 9 to the dome 7 so as to be axially displaceable but non-rotatable.

However, it is also conceivable for the guide rails 10 to be mounted on the lifting spindle 9, whilst the carriages 11 are secured to the dome 7.

Along with the coupling, described here, of dome 7 and lifting spindle 9 by means of a carriage arrangement, it is also conceivable to effect the coupling according to the principle of the ball bush guide or the polygon connection. In all cases it must be ensured that the lifting spindle 9 is coupled to the dome 7 so as to be displaceable in the axial direction but non-rotatable.

In addition, the dome 7 has four projections 12 that are located between the guide rails 10. The dome 7 is additionally reinforced by the projections 12 such that its torsional rigidity is increased even further.

The lifting spindle 9 has threaded bores 13 at the upper end and it can be screw-connected to an object to be lifted by means of said threaded bores. A thread 14 is provided on the outer surface of the lifting spindle 9, said thread engaging a thread 15 that is realized on the inner surface of a threaded bush 16.

The threaded bush 16 is also in the form of a hollow cylinder and surrounds the lifting spindle 9. In addition, the threaded bush 16 has a ring-shaped projection 17, to which a worm gear 18 surrounding the threaded bush 16 in a ring-shaped manner is screw-connected.

In addition, the projection 17 of the threaded bush 16 is screw-connected to the upper inner ring 19 and to the lower inner ring 20 of an axial radial bearing 21 known in the prior art. The outer ring 23 of the axial radial bearing 21, rotatable relative to the upper and lower inner ring 19, 20, is in its turn screw-connected to the base plate 3, such that the threaded bush 16 is mounted so as to be rotatable relative to the base plate 3 and the housing 5 but non-displaceable in the axial direction.

In addition, a bearing 24 is provided at the upper region of the threaded bush 16, the outer ring 25 of which is accommodated in the housing 5 and the inner ring 26 of which is accommodated in the threaded bush 16, the threaded bush 16 thus also being secured in a radial manner.

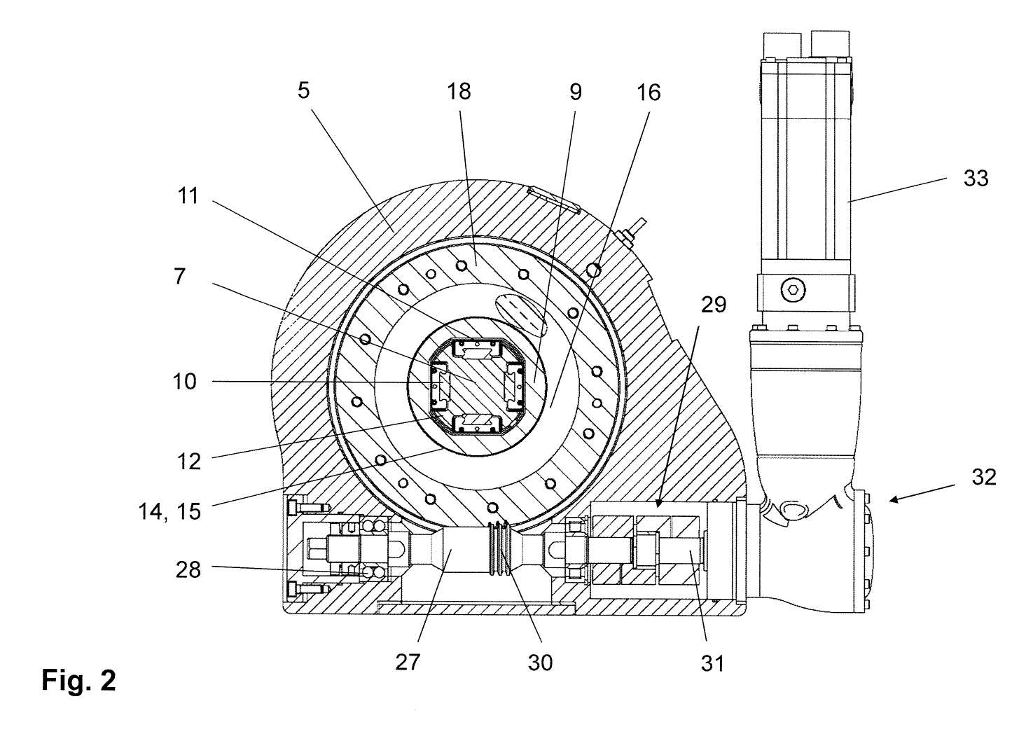

In addition, a worm shaft 27 located at right angles to the axial direction of the dome 7, the lifting spindle 9 and the threaded bush 16 is provided in the housing 5, said worm shaft being accommodated at one end in a bearing arrangement 28 and being coupled at the other end to an axially insertable shaft coupling 29 that is also provided in the housing 5 (see FIG. 2). In the central part the worm shaft 27 has a threaded portion 30, the worm shaft 27 being located in such a manner that the threaded portion 30 engages the worm gear 18 that is screw-connected on the projection 17 of the threaded bush 16. Consequently a rotation of the worm shaft 27 causes a rotation of the threaded bush 16.

By using a design with a worm gear 18 and a worm shaft 27, it is possible to exert a very high torque onto the threaded bush 16 such that it is possible to lift high loads using the lifting device 1.

The shaft coupling 29 is connected in its turn to the output shaft 31 of a gearing, in this case of a bevel gear 32, the input of which is connected to a drive motor 33. In this case the gearing and in particular the bevel gear 32 used here is realized in such a manner that the speed of the output shaft 31 is reduced relative to that of the drive motor 33.

Consequently the worm gear 18, the worm shaft 27, the shaft coupling 29, the bevel gear 32 and the drive motor 33 form a drive unit for the rotating drive of the threaded bush 16. In this case, the achievement through the shaft coupling 29 is that the output shaft 31 and the worm shaft 27 do not have to be aligned completely precisely one relative to the other. In addition, there is no direct positive locking between the threaded bush 16 and the drive motor 33 such that rotational vibrations are damped.

Finally a sensor 34 is mounted on the outside of the housing 5, said sensor being able to engage an object that is screw-connected to the lifting spindle 9 by means of the threaded bores 13 in order, in a direct manner, to detect the distance the object is lifted by means of the lifting device 1.

The lifting device 1 operates as follows. When the output shaft of the drive motor 33 rotates, the speed of the bevel gear 32 is reduced such that the output shaft 31 of the bevel gear 32 as well as the worm shaft 27 rotate at a reduced speed. At the same time, the worm shaft 27 sets the worm gear 18 and consequently the threaded bush 16 into rotation. The internal thread 15 of the threaded bush 16 engages the external thread 14 on the outer surface of the lifting spindle 9, and as the lifting spindle 9 is locked against rotation by means of the dome 7 via the linear guide, but is axially moveable, no rotation occurs but rather a straight-line movement of the lifting spindle 9 along the dome 7. The lifting spindle 9 is therefore moved out of the housing 5 or back into said housing.

Consequently, the achievement of arranging the dome 7 with linear guide in the interior of the lifting spindle 9 is that with a large total travel, a more compact design is nevertheless possible compared to the prior art as no additional guide elements are necessary in the axial direction of the lifting spindle 9, rather these are located in the interior of the hollow-cylindrical lifting spindle 9.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A lifting device for lifting an object, said lifting device comprising:
a housing;
a cylindrical lifting spindle presenting an external thread on an outer surface thereof;
a threaded bush surrounding the lifting spindle and presenting a corresponding internal thread in engagement with the external thread;
a drive unit configured for rotating the threaded bush,
said lifting spindle being mounted in the housing so as to be displaceable in an axial direction but non-rotatable,
said lifting spindle being in the form of a hollow cylinder; and
a dome located within an interior of the lifting spindle and being connected in a non-rotatable manner to the housing,
said lifting spindle being mounted on the dome so as to be non-rotatable but axially displaceable.

2. The lifting device according to claim 1,
said threaded bush including a worm gear surrounding the threaded bush; and
a worm shaft engaging the worm gear configured to be driven in a rotating manner.

3. The lifting device according to claim 2,
said worm shaft being connected to a drive motor with a shaft coupling and a bevel gear assembly.

4. The lifting device according to claim 1,
one of said dome and said lifting spindle including a guide rail facing toward the other of said dome and said lifting spindle,
said guide rail extending in an axial direction of the lifting spindle; and
a carriage secured to a surface of the other of said dome and said lifting spindle,
said carriage being disposed in an axially displaceable manner in the guide rail.

5. The lifting device according to claim 4,
said lifting device including a plurality of guide rails distributed substantially uniformly over one of an outside circumference of the dome and an inner surface of the lifting spindle,
said lifting device including a plurality of carriages distributed substantially uniformly over the other of the outside circumference of the dome and the inner surface of the lifting spindle.

6. The lifting device according to claim 5,
said dome including projections disposed between the guide rails,
said projections extending in an axial direction on an outer surface of the dome.

7. The lifting device according to claim 2,
one of said dome and said lifting spindle including a guide rail facing toward the other of said dome and said lifting spindle,
said guide rail extending in an axial direction of the lifting spindle; and
a carriage secured to a surface of the other of said dome and said lifting spindle,
said carriage being disposed in an axially displaceable manner in the guide rail.

8. The lifting device according to claim 7,
said lifting device including a plurality of guide rails distributed substantially uniformly over one of an outside circumference of the dome and an inner surface of the lifting spindle,
said lifting device including a plurality of carriages distributed substantially uniformly over the other of the outside circumference of the dome and the inner surface of the lifting spindle.

9. The lifting device according to claim 8,
said dome including projections disposed between the guide rails,
said projections extending in an axial direction on an outer surface of the dome.

10. The lifting device according to claim 3,
one of said dome and said lifting spindle including a guide rail facing toward the other of said dome and said lifting spindle,
said guide rail extending in an axial direction of the lifting spindle; and
a carriage secured to a surface of the other of said dome and said lifting spindle,
said carriage being disposed in an axially displaceable manner in the guide rail.

11. The lifting device according to claim 10,
said lifting device including a plurality of guide rails distributed substantially uniformly over one of an outside circumference of the dome and an inner surface of the lifting spindle,
said lifting device including a plurality of carriages distributed substantially uniformly over the other of the outside circumference of the dome and the inner surface of the lifting spindle.

12. The lifting device according to claim 11,
said dome including projections disposed between the guide rails,
said projections extending in an axial direction on an outer surface of the dome.

13. The lifting device according to claim 3,
said bevel gear assembly including a bevel gear.
